(19) United States
(12) Patent Application Publication
(10) Pub. No.: US 2012/0225645 A1
(43) Pub. Date: Sep. 6, 2012

(54) Low Cost System converting any Smartphone to a Remote Controller

(76) Inventor: Michael Sivan, Shatin (HK)

(21) Appl. No.: 13/039,328

(22) Filed: Mar. 3, 2011

(51) Int. Cl. H04W 4/00

(52) U.S. Cl. 455/418

(57) ABSTRACT

Low cost system converting any Smartphone into an Infrared or radio controlled Remote Controller, as a green and advanced alternative to conventional remote controllers for toys, audio-video devices, alarms, gate openers, and more.

### PRIORITY DATE

Provisional application 61/444,793

### TECHNICAL FIELD

Universal Remote Control system on a Smartphone

### BACKGROUND

Remote Control Units (RCU) for toys (e.g. cars, helicopters, robots, etc.) and Consumer Audio/Video Devices (e.g. TV, Set-top, Players, HIFI, etc.) typically comprise of a human sensory input system (e.g. buttons, levers, touch pad, tilt sensors, microphone, etc.) which converts human input into respective electronic signals. Such signals are then encoded, modulated and transmitted by radio frequency or by Infra-Red. Such RCUs are normally provided as an accessory together with any such controlled product. They come in any shape, color, quality and number of buttons. They also transmit differently encoded wireless signals and typically control one device only, or a few devices of same brand. Consequently, a typical consumer nowadays has a mess of non-matching RCUs all over the house. Some improvement has been made by the launch of universal remote controllers which control several items of different brands. Still they are quite bulky with a complicated layout of too many buttons, and this eventually puts off most users.

In parallel, and not related to the above, smartphones (e.g. iPhones, Android based smartphones, Blackberry, Windows Phone, etc.) are gaining huge popularity. Hundreds of millions are sold, yet the continuous improvements and new designs keep market's demand growing with no saturation in sight. Smartphones are elegant, smart, sleek, personalized, and accompany their owners virtually 24/7. They are used for listening to music, browsing the internet, watching video, playing games, taking photos/videos, emailing, calculating, reading/writing documents and of course also for making phone (and video) calls.

Looking at these two worlds, remote controlled items and smartphone, raises the obvious approach—smartphones should also be able to remote control toys and consumer audio/video devices. Instead of multiple remote controllers and multiple buttons—simply use a smartphone with a few screens personalized to owner's specific home devices, and each screen with personalized virtual buttons on screen. Even use the tilt and microphone as additional human input alternatives.

Yet, smartphones output is limited to Wifi and Bluetooth, whereas very few remote-controlled consumer electronics or toys incorporate such technologies because current infra-red remote controllers are much cheaper and much easier for manufacturing. Also, most consumer electronic factories rarely employ the required Radio-Frequency (RF) engineers or invest in the very expensive test equipment as needed for RF engineering. Consequently, the high-tech of the Smartphones on one side, and the extremely cost-conscious consumer electronics industry on the other side—remain incompatible.

The present invention provides for a low-cost adaptation system comprising of both software and hardware, which allow any smartphone to be configured to be a remote-controller for any consumer electronics, audio/video devices, and toys.

### SUMMARY OF INVENTION

A Converter (FIG. 1, part 1) having a standard 3.5 mm audio jack connects to the audio socket 3 of the smartphone 4. The Adapter comprises of one (or more) Infrared (I/R) LED 5, one I/R sensor, an electronics circuit (inside) and one (or more) button cell batteries. The Smartphone includes a specific RC application which is available on the internet for download and standard installation.

Operation (Block diagram in FIG. 2): User inputs a command to the Smartphone 21 typically by touch, tilt and/or voice. The installed application configures the Smartphone to convert user's input command into distinguishable electronic signals 22 which are in different amplitudes but all limited in their frequency range to audio frequencies only. These signals are delivered to the audio socket and passed to the Converter 23.

The Converter comprised of an MCU 24 with an embedded software. It is configured to receive these audio frequency signals and convert them into a train of binary codes which modulate a carrier of 38 KHz that drives the external I/R LED. This I/R signal is received by the controlled unit (e.g. toy, audio/video device, etc.). The binary code is configured by the Application on the smartphone, together with the embedded software on the MCU, to match exactly the code set which that specific controlled product already recognizes (by the fact it is the same one already used with its own originally supplied I/R remote controller). Accordingly, it is achieved that the Smartphone is remote controlling the controlled device.

The above-mentioned binary code varies from product to product and from brand to brand. As such, the application on the smartphone, in conjunction with the embedded software on the converter, is configured to handle different code sets in two main methods—Library Code-Set and Instant Learn as described below.

Library Code-Set: The smart-phone application will include Code-Sets of various products, brands and model numbers. The downloadable application will constantly be updated automatically, as do today most smartphone downloadable applications, to include additional new code-sets. This method described above is an example, and there could be various other methods, free of charge or payable by the user.

Instant Learn: The smartphone application will go into Learn mode, in which the specific code-set of the specific controlled item will be learned and memorized by the application. The learn procedure is done step by step using the original remote controller (the one supplied with the controlled item). Each time one button on the original remote controller is pressed while facing to the converter's I/R sensor. The I/R sensor 31 (FIG. 3) receives the infrared signal and the MCU 32 of the converter with its embedded software is configured to convert that specific button code into a corresponding and specific audio frequency signal. That signal 33 is fed back into the smartphone through the same 3.5 mm jack's, making use of the Microphone contact (the one normally used by the smartphone to connect the microphone input of a wired headset/ear set). The smartphone with its application is configured to receive that audio signal, convert it to a specific internal code, then prompt the user activate any specific input (touch any button, tilt in any direction, say a specific word, etc.) and finally assign that specific code—to that specific input.

Automatic and pre-programmed commands: The above describes the method in this invention of remote controlling by a Smartphone, in which the wireless transmitted remote control commands correspond to user's input commands. However, the wireless transmitted commands may also be automatically created by the Smartphone upon certain scenarios as configured by specific software applications installed on the smartphone. Such scenarios could be one or more, but not limited to, the following: (a) A pre-determined sequence configured to start at a specific time or condition; (b) a response by the Smartphone to a received SMS, email, instant-message, activity in another application on the smartphone (e.g. game, video, music, etc.), GPS reading, wifi signal detected; (c) A signal received from the controlled item itself, whether through the Converter in this invention or otherwise.

### ADDITIONAL EMBODIMENTS

The method described above refers to embodiment making use of Infrared wireless transfer. This is the most common one for consumer electronics, audio/video devices and indoor remote controlled toys (e.g. indoor RC helicopters, planes and cars). However, this invention applies to other embodiments as well, in which the Infrared part is replaced by an unlicensed radio frequency range (e.g. 2.4 GHz, etc.). This is applicable for outdoor remote controlled toys, for various remote controlled alarm systems, etc.

The embodiments described above refer to controlled items which by their original nature and design are intended for being remote-controlled. However, there could be an embodiment of an added dedicated receiving unit that connects to the controlled unit. As an example, a low cost infrared receiving unit could be designed to connect to the light switch in the room, and then the switching on/off of the light could be remotely-controlled by the Smartphone (with its converter and matching application).

### ADVANTAGES

No more confusing multiple-button multiple remote controllers scattered all around, each with a different look and normally not matching each other. No more complex learning for each new product's controller, no more running out of batteries, no more breakage, loss, or wear with age. Instead, one sleek application on your latest smartphone (which you always carry with you anyhow), with your preferred personalized virtual buttons (shape, size, color, position of your own liking) and with an easy switch from one screen to the other—each screen controlling one device (e.g. your TV, your cable channel control, your DVD player, your HIFI system, etc.).

Smartphone application can configure the smartphone to issue a sequence of remote control commands or have interactive signal communication with the remote device (e.g. guiding a toy car through a maze, etc.).

Interactive games between two smartphones without making use of the battery draining Bluetooth and WIFI, and without going through the phone service provider.

‘Green’ and environmental friendly—manufacturers will not have to include anymore a remote control unit with each shipped product, which means (a) lower manufacturing cost; (b) less wastage when discarding an old product; (c) less consumption of those AA or AAA batteries of the conventional remote controllers.

### BRIEF DESCRIPTION OF DRAWINGS

FIG. 1 Audio to Infra-Red Converter

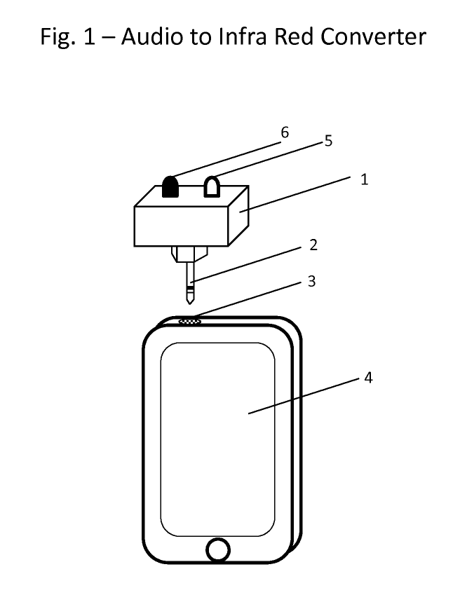

FIG. 2 Block Diagram

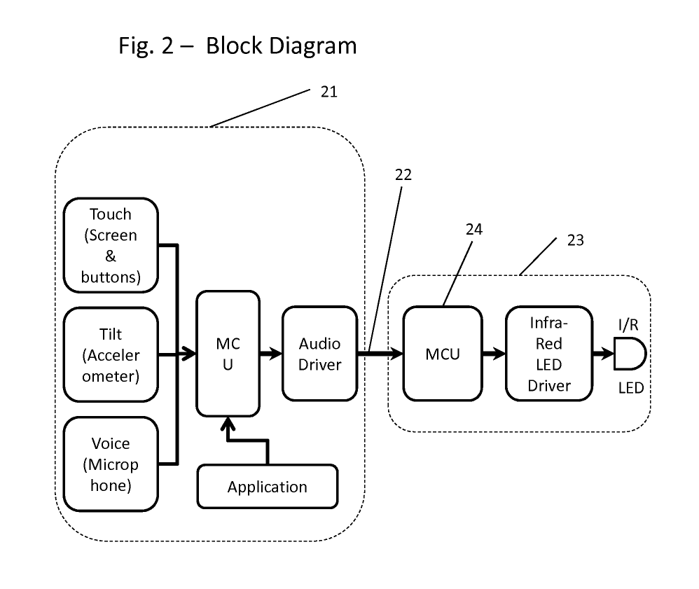

FIG. 3 Instant Learn Block Diagram

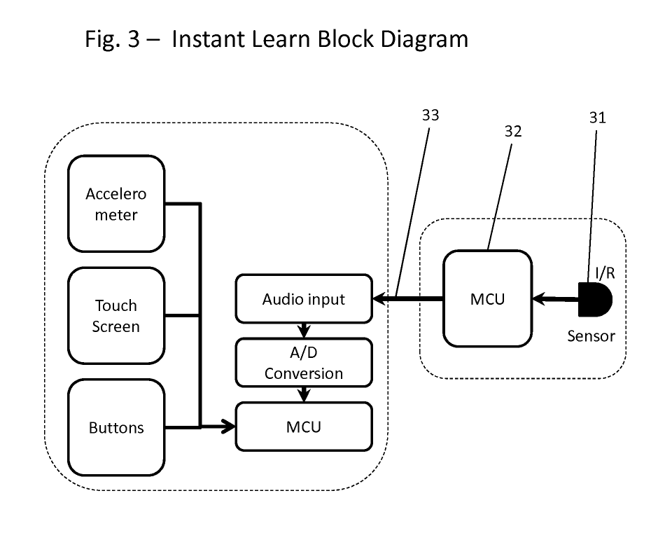

1. System converting a Smartphone into an Infrared Remote Control to control an item (e.g. remote-controlled toy, consumer audio/video device, light and power switches, alarms, doors, etc.) which comprises of a Converter and a software application installed on the smartphone; wherein
the Smartphone is configured by that software application to convert one or a combination of (a) user's input command which can be any combination of one or more of a touch on screen, or activation of a hardware control button, or tilt of the smartphone, or voice; (b) a reading of the GPS receiver; (c) an incoming SMS, and/or email, and/or instant-message; (d) a signal from another application running on the Smartphone—into a corresponding electronic signal which is within the audio frequency range, and which is then transferred to the smartphone's audio socket output pin(s);
the Converter comprises of one or more infra-red LEDs, and an audio jack that plugs into the audio socket of the Smartphone and receives through its pin(s) the said audio frequency signal; the Converter is then configured to convert that signal into a corresponding specific binary code which modulates a 38 KHz carrier that modulates the Infra-Red LEDs which transmit encoded infrared signals data towards the remote controlled item, which receives such signals decodes them and reacts to them.

2. System converting a Smartphone into a Remote Control as per claim 1, except that the infrared part is replaced by radio frequency.

3. System converting a Smartphone into a Remote Control as per claim 1 or 2, except that wireless signal is received by a matching wireless receiver specifically designed to connect to a product or facility and control it.
